(19) United States
(12) Patent Application Publication
(10) Pub. No.: US 2022/0000131 A1
(43) Pub. Date: Jan. 6, 2022

(54) METHOD FOR PRODUCING A COLD MIXED MILK DRINK

(71) Applicant: EMMI SCHWEIZ AG, Luzern (CH)

(72) Inventors: Walter BARTLOME, Ablandschen (CH); Thomas BUELER, Staufen (CH); Alfred Hans HOFER, Thurnen (CH); Remo GMUR, Luzern (CH); Martina KOHLER, Luzern (CH); Isidor LAUBER, Grosswangen (CH); Georg SCHAFER, Wauwil (CH); Christine SIEBER, Gansingen (CH); Roger WALLISER, Suberg (CH); Armin WASSERFALLEN, Lyss (CH)

(73) Assignee: EMMI SCHWEIZ AG, Luzern (CH)

(21) Appl. No.: 17/428,084

(22) PCT Filed: Feb. 7, 2020
(86) PCT No.: PCT/EP2020/053102

§ 371 Date: Aug. 3, 2021

(30) Foreign Application Priority Data
Feb. 8, 2019 (CH) 157/19

(51) Int. Cl. A23C 3/02; A23C 9/156

(52) U.S. Cl. CPC A23C 3/02; A23C 9/1565

(57) ABSTRACT

A method for producing a cold mixed beverage made of milk and an acidic component having a denaturing step of the milk is disclosed. The milk is heated to a denaturing temperature T_{DENAT} that is in a range of 72° C. to 155° C. prior to mixing with the acidic component and is maintained at the denaturing temperature T_{DENAT} for a denaturing period t_{DENAT} and then the denatured milk is mixed with the acidic component. The mixture is heat treated to increase the shelf life. The mixture is heated to a temperature T_{HALT} which is in a range of 63° C. to 155° C., and maintained at the temperature T_{HALT} for a heat treatment period t_{HALT}. The heat-treated mixture is homogenized at a homogenizing pressure Pₕₒₘ which is in a range of 75 bar to 275 bar, and then cooled to a temperature that is in the range of 4° C. to 25° C.

### TECHNICAL HELD OF THE INVENTION

The present invention relates to a method for producing a cold, mixed beverage made of milk and an acidic component, and to a corresponding cold, milk mixed beverage.

### DESCRIPTION

Cold, milk mixed beverages are available on the market for quite some time. Additives such as stabilizers, emulsifiers, acidity regulators and/or binders are frequently added to such mixed beverages. Such additives are intended to stabilize a mixed milk beverage in terms of its consistency and properties, Acidity regulators are used, for example, in the manufacture of a mixture of milk and an acidic ingredient to prevent flocculation during production or storage. This enables a corresponding milk product to essentially retain its original consistency over a longer period of time.

In recent times the trend in the food industry has also been to offer products with as few additives as possible. However, if the milk is to be mixed with an acidic component such as coffee, for example, the challenge is to counteract the effects of, for example, the acidity of the coffee and/or the high temperature of freshly brewed coffee in an alternative way and to prevent unwanted flocculation during the production and/or the storage.

### SUMMARY OF THE INVENTION

It is the object of the present invention to provide an alternative method by which a mixed beverage made of milk and an acidic component can be prepared and stored with as little flocculation as possible.

The object is solved by a method for producing a cold, mixed beverage made of milk and an acidic component, comprising the following steps in this order:

A denaturing step of the milk. In this step, the milk is heated to a denaturing temperature T_{DENAT} before mixing with an acidic component. The denaturing temperature T_{DENAT} is in a range of 72° C. to 155° C. The milk heated in this way is kept at the denaturing temperature T_{DENAT} for a denaturing period t_{DENAT}.

Subsequently, the denatured milk is mixed with an acidic component.

The mixture of the milk and the acidic component is then heat-treated to increase shelf life. For this purpose, the mixture is heated to a temperature T_{HALT}, which is in a range of 63° C. and 155° C., and the mixture is kept at the temperature T_{HALT} for a heat treatment period t_{HALT}.

Subsequently, the heat-treated mixture is homogenized at a homogenization pressure P_{HOM} which is in a range of 75 bar to 275 bar, and after the homogenization, the mixture is cooled to a temperature which is in a range of 4° C. to 25° C.

The milk and the acidic component are mixed in such a ratio that the mixture, after the homogenization and the cooling, has a pH value that is in the range of 5.8 and 7.0.

The method allows milk to be mixed with an acidic component without significant flocculation being formed during the mixing or manufacturing process.

It has been found that, in particular, by subjecting the milk to a denaturing step prior to mixing—i.e., without the acidic component—it is possible to produce a corresponding cold mixed milk beverage which is stable against potential flocculation during production and storage. Thus, if the milk is subjected to a separate denaturing step as described herein, the milk can be mixed with an acidic component without risk of flocculation, and optionally even under elevated temperature conditions, if desired for production and/or energy purposes. As such, the mixture can then be subjected to a common heat treatment as required for preservation and finally homogenized before storage as a finished product. It is currently assumed that the separate denaturing step of the milk reduces the proportion of native milk proteins and thus there are correspondingly fewer flocculable components in the milk already at the time of mixing.

The method described here may allow the use of acidity regulators in particular to be dispensed with. Such acidity regulators are used in conventional methods in particular when an acidic component has to be added to milk, and serve to stabilize the pH value and thus ultimately counteract flocculation of milk proteins by the acidic component.

The method described here can also allow other additives such as stabilizers, emulsifiers and/or binders not to be used either, since the sequence of temperature and pressure treatments of the various ingredients described above alone can produce a stable mixed milk beverage.

A mixture with a final pH in a range of 5.8 to 7.0 has been found to be suitable for producing a final product that is stable with respect to flocculation solely by the choice of process parameters. A final product is understood here as the finished product as bottled and finally sold in the store. If the final pH value is too low, the risk of undesirable flocculation during production and/or storage is again increased.

The denaturing step of the milk can take place, for example, in a tank that can be heated to the denaturing temperature T_{DENAT} or in a heat exchanger, such as a plate or tube heat exchanger.

Heat treatment of the mixture of milk from the denaturing step and the acidic component serves to increase shelf life, as is necessary for the sale of perishable, natural dairy products. It can be carried out, for example, directly by means of infusion or uperization, or indirectly, for example, by means of tubular or plate heat exchangers. Depending on the type of heat treatment, for example pasteurization or high pasteurization or ultra-high temperature heating, the appropriate suitable device or facility can be selected.

Milk or milk mixtures can be homogenized in any suitable homogenizer, for example in a two-stage piston homogenizer. The pressures given here correspond in each case to the total pressure applied during homogenization.

It may be necessary to cool the mixture to a homogenization temperature T_{HOM} for homogenization after the heat treatment.

Cooling can be carried out passively by transferring the homogenized mixture to a storage room at the desired temperature and leaving it there so that it cools over time to the temperature of the storage room. However, it is particularly advantageous to actively cool the heat-treated and homogenized mixture, for example with a heat exchanger such as a plate heat exchanger or tube heat exchanger.

The temperature to which the now heat-treated and homogenized mixture is finally cooled can correspond, for example, to the storage temperature at which the mixture is subsequently to be stored until filling. The storage temperature in turn depends, for example, on the type of mixture and heat treatment carried out to increase the shelf life of the mixture. For example an ultra-high temperature treated mixture can be stored at a higher temperature, such as room temperature, as long as the storage is carried out in an aseptic environment. A pasteurized mixture, on the other hand, may require storage at lower temperatures, for example, 4° C. to 12° C. Again, if necessary, storage should be in an aseptic environment to avoid recontamination.

Storage in a sterile tank, for example, is suitable. The use of such a sterile tank is particularly suitable for avoiding recontamination, as it is itself treated to be germ-free, i.e. sterile.

Mixing is understood here as the mixing process of the milk from the denaturing step and the acidic component. The addition of, for example, flavoring substances and/or other ingredients is rather understood as addition and not as it may be provided that for the purpose of mixing, the milk and the acidic component are brought to the same temperature, for example. However, it has been shown that due to the separate denaturation treatment of the milk, the temperature at which mixing is performed has no or no significant and thus negligible influence on the stability of the mixed milk beverage produced. The choice of the temperatures for the milk and the acidic component can therefore also be coordinated in view of process related aspects and energy related aspects.

In the context of the present invention, milk is understood to mean a liquid component based on milk. In this sense, one can also speak of the milk component. In this context, milk may be, for example: whole milk, skimmed milk, semi-skimmed milk, milk standardized in fat content, cream, or combinations thereof. Milk standardized in fat content is usually understood to mean a mixture of semi-skimmed milk or skimmed milk and cream. Skimmed milk, for example, typically has a fat content of about 0.05% and cream a fat content of 37%. By selecting an appropriate mixing ratio of the different starting milk types, a desired fat content of the milk component can be set in a targeted and reproducible manner. Milk can also be, for example, one or more milk fractions or a milk preparation. A milk fraction is understood here to be a fraction of milk obtained by means of a separation process such as filtration and/or centrifugation. Examples are whey or buttermilk or components of such a fraction such as milk proteins or milk fats. The milk fraction may be for example, a powder or a liquid. Milk may also be a combination of one or more of the above-mentioned types of milk with one or more milk fractions.

Furthermore, the milk may for example have already been subjected to a treatment to reduce the lactose content before mixing, or such a treatment may be applied to the mixture after the homogenization step and/or after the cooling step if no recontamination can take place. For this purpose, lactase may for example be added to the milk, or lactase may be added to the mixture after the homogenization step and before storage.

The milk may be pre-stored prior to the start of the denaturing step, and brought into the process at the desired start of denaturation, if necessary as described later, the milk from pre-storage may first be subjected to prehomogenization. Suitable storage temperatures for the pre-stored milk are in the range of 4° C. to 8° C.

Flavoring substances include, for example, sugar or types of sugar such as caramel sugar syrup, glucose syrup, maltodextrin, honey, agave syrup and preparations thereof, sweeteners, cocoa powder, chocolate powder, and other flavoring substances. Such flavoring substances may be flavors, natural flavors, flavor providing substances, flavoring extracts, artificial flavors, or combinations thereof. To be distinguished from flavoring substances are additives such as acidity regulators, stabilizers, emulsifiers and binders, which are used rather to influence the consistency or stability of the manufactured dairy beverage.

The acidic component may be, for example, fruit juice, fruit juice concentrate, fruit pulp, fruit puree as well as fruit preparations thereof, vegetable juice, vegetable juice concentrate, cereals and other fermented natural ingredients as well as preparations thereof, coffee, and/or tea, tea infusion and (liquid) tea extract for example from powder or paste as well as preparations thereof.

The information given here on treatment temperatures, times and pressures is particularly suitable for the use of coffee or coffee extract as the acidic component. If another acidic component is to be used, the settings can be adapted accordingly within the scope of the specified parameters.

In one embodiment of the method according to the invention, which may be combined with any of the embodiments mentioned and yet to be mentioned, unless in contradiction therewith, the denaturing period t_{DENAT} is in a range of 30 sec to 1 h.

The denaturing period t_{DENAT} is adapted to the selected denaturing temperature T_{DENAT}. With regard to the denaturing temperature T_{DENAT} and the denaturing period t_{DENAT}, the following applies: the higher the denaturing temperature T_{DENAT}, the shorter the denaturing period t_{DENAT}. By adjusting the denaturing temperature T_{DENAT} and the denaturing period t_{DENAT}, it is intended to influence the degree of denaturation of native whey proteins and to achieve a relatively high degree of denaturation of these proteins. It is currently assumed that a relatively high denaturation of native whey proteins is achieved by the denaturing step, which is in a range of 60 to 99%, or a denaturation that is in a range of 60% up to 100%, if this refers specifically to the whey protein β-lactoglobulin B. Subsequent steps in the manufacturing process, such as mixing with an acidic component or preservation, or even storage, would then have fewer native milk proteins that could flocculate. The minimum required or the optimum degree of denaturation, which should be targeted for a stable mixed milk beverage, can be influenced not only by the raw material properties but also by process-related aspects. If a specific degree of denaturation to be achieved is targeted in the above-mentioned range, the denaturing period t_{DENAT} to be used can thus also be determined, for example, by taking into account additional aspects such as process engineering conditions or also raw material properties (such as acid content of the acidic component, acid content in the formulation, . . . ).

An excessively long denaturation, which could trigger a so-called Maillard reaction, is not desirable as this could lead to an undesirable coloration and/or change in taste of the milk or the subsequent milk mixture. A shorter denaturing period may not be desirable, particularly from a process engineering point of view.

In one embodiment of the method according to the invention, which may be combined with any of the embodiments mentioned and yet to be mentioned, unless in contradiction therewith, a degree of denaturation of the native whey protein β-lactoglobulin B is produced by means of the milk denaturing step, which is in a range from 60% to 100%.

Accordingly, it may be provided, as mentioned, to achieve a degree of denaturation of the native whey protein β-lactoglobulin B in this range by adjusting, for example, the denaturing period t_{DENAT} and/or the denaturing temperature T_{DENAT}, and, optionally, by taking into account further process conditions such as, for example, conditions during mixing of the milk and the acidic component and/or during homogenization and/or raw material properties of the milk and/or the acidic component.

The whey protein β-lactoglobulin B has established itself among experts as a suitable standard for determining or assessing the degree of denaturation of a milk component, since it represents a very sensitive fraction of the total whey proteins with regard to denaturation. The degree of denaturation of β-lactoglobulin B is described as the percentage of β-lactoglobulin B presented in denatured form relative to the total β-lactoglobulin B fraction.

In this context, denaturation of 100% of the β-lactoglobulin B fraction is referred to when values above 99% are achieved by measurement.

In one embodiment of the method according to the invention, which may be combined with any of the embodiments mentioned or yet to be mentioned, unless in contradiction therewith, a degree of denaturation of the native whey protein β-lactoglobulin B is produced by means of the milk denaturing step, which is in a range from 30% to 100%, in particular in a range from 80% to 99% or in a range from 80% to 95%.

In one embodiment of the method according to the invention, which may be combined with any of the embodiments mentioned and yet to be mentioned, unless in contradiction therewith, a degree of denaturation of the native whey protein β-lactoglobulin B is produced by means of the milk denaturing step, which is in a range from 90% to 100%.

It may be that a denaturing period t_{DENAT} that is in a range of 240 sec to 420 sec, even more specifically in a range of 240 sec to 320 sec, is particularly suitable. For example, a denaturing period t_{DENAT} of 420 sec is suitable for a denaturing temperature T_{DENAT} of 86° C., while a denaturing period t_{DENAT} of 320 sec is suitable for a denaturing temperature T_{DENAT} of 88° C., for example, or a denaturing period t_{DENAT} of 240 sec is suitable for a denaturing temperature T_{DENAT} of 95° C. For example, if a denaturing temperature T_{DENAT} of 72° C. is used, the suitable denaturing period t_{DENAT} is 1 h (hour).

For example, if a denaturing temperature T_{DENAT} of 155° C. is used, the appropriate denaturing period t_{DENAT} is approximately 30 sec.

In one embodiment of the method according to the invention which may be combined with any of the embodiments mentioned and yet to be mentioned, unless in contradiction therewith, the denaturing period t_{DENAT}, which is in a range from 60 sec to 420 sec, is preferably in a range from 100 sec to 320 sec.

In particular, a denaturing period t_{DENAT} may be suitable, which is in the range of 100 sec to 200 sec.

As an example, a denaturing period t_{DENAT} of 120 sec is mentioned. This denaturing period t_{DENAT} may be suitable if the other conditions of the method (process engineering conditions or raw material engineering conditions as mentioned above) can be adapted in such a way as to achieve a degree of denaturation in one of the ranges described above.

In one embodiment of the method according to the invention, which may be combined with any of the embodiments mentioned and yet to be mentioned, unless in contradiction therewith, the denaturing period t_{DENAT} is in a range of 240 sec to 320 sec, with a denaturing temperature T_{DENAT} in a range of 86° C. to 95° C.

In one embodiment of the method according to the invention, which may be combined with any of the embodiments mentioned and yet to be mentioned, unless in contradiction therewith, the denaturing step of the milk is carried out at a denaturing temperature T_{DENAT} in a range from 86° C. to 95° C.

In one embodiment of the method according to the invention, which may be combined with any of the embodiments mentioned and yet to be mentioned, unless in contradiction therewith, the denaturing temperature T_{DENAT} is 90° C. and the denaturing period t_{DENAT} is 300 sec.

In one embodiment of the method according to the invention which may be combined with any of the embodiments mentioned and yet to be mentioned, unless in contradiction therewith, the denaturing temperature T_{DENAT} is 90° C. and the denaturing period t_{DENAT} is 120 sec.

It has been shown that, even with a comparatively shorter denaturing period t_{DENAT}, a sufficiently high degree of denaturation is achieved, which makes it possible to produce a mixture that is sufficiently stable to flocculation, for example, during mixing or also during storage.

In one embodiment of the method according t the invention, which may be combined with any of the embodiments mentioned and yet to be mentioned, unless in contradiction therewith, the homogenization of the heat-treated mixture is carried out at a temperature T_{HOM} ranging from 65° C. to 80° C.

It may be provided that in one embodiment of the method, which may be combined with any embodiment mentioned and yet to be mentioned, the homogenization of the mixture is carried out at a pressure P_{HOM} which is in a range from 75 bar to 250 bar, preferably in a range from 100 bar to 170 bar, most preferably in a range from 100 bar to 150 bar.

In one embodiment of the method according to the invention, which may be combined with any of the embodiments mentioned and yet to be mentioned, unless in contradiction therewith, the heat treatment of the mixture is a pasteurization. For this purpose, the temperature T_{HALT} is in a range from 63° C. to 133° C. and the heat treatment period t_{HALT} is in a range from 2 sec to 200 sec. By means of pasteurization, the mixture is treated in a gentle manner for killing, vegetative pathogenic germs. The corresponding pasteurized end product can be stored stably under refrigeration for approximately 30 to 60 days. During pasteurization, the temperature T_{HALT} and the heat treatment period t_{HALT} are matched. For example, batch pasteurization can be carried out at 63° C. for approximately 2000 sec. In the case of high pasteurization, i.e. pasteurization in the higher temperature range, for example, a temperature of 125° C. can be applied for circa 2 to 8 sec.

In one embodiment of the method according to the invention, which may be combined with any of the embodiments mentioned and yet to be mentioned, unless in contradiction therewith, the heat treatment of the mixture is an ultra-high temperature heating. For this purpose, the temperature T_{HALT} is in a range of 130° C. to 155° C. and the heat treatment period t_{HALT} is in a range of 2 sec to 8 sec. By means of ultra-high temperature heating, not only vegetative germs are killed, but also spores that may be present. The corresponding ultra-high heated final product can be stored unrefrigerated for 90 days or more. Ultra-high temperature heating, also typically involves matching the temperature T_{HALT} and the treatment period t_{HALT}. For example, ultra-high heating can be carried out at 130° C. for 10 sec to 30 sec. If a higher temperature is to be selected, a temperature of 155° C. for 1 sec to 10 sec is possible, for example.

Alternatively, the heat treatment may be sterilization, provided that the properties of the mixture are not affected.

In one embodiment of the method according to the invention, which may be combined with any of the embodiments mentioned and yet to be mentioned, unless in contradiction therewith, the milk is prehomogenized immediately before the denaturing step. The prehomogenization pressure p_{PRE} is in a range of 100 bar to 300 bar. In particular, the prehomogenization pressure p_{PRE} may be in a range of 150 to 250 bar.

Such prehomogenization of the milk can additionally improve stability and reduce flocculation. It is assumed that by additionally reducing the diameter of the fat globules in the milk, the protein structures in the milk are additionally changed, which in turn contributes to the reduction of flocculation.

In one embodiment of the method according to the invention, which may be combined with any of the embodiments mentioned and yet to be mentioned, unless in contradiction therewith, the prehomogenization is carried out at a temperature which is in a range from 65° C. to 80° C. The temperature of the prehomogenization may, for example, be adapted to the properties of the milk and/or selected according to plant engineering aspects. For example, a higher temperature T_{PRE} is selected if a milk with a higher fat content is used.

In one embodiment of the method according to the invention, which may be combined with any of the embodiments mentioned and yet to be mentioned, unless in contradiction therewith, the milk and/or the acidic component comprises flavoring substances. Whether or to what extent such flavoring substances are added to the milk or the acidic component, or both, may be decided in view of process engineering aspects. In order not to counteract the effect regarding the increase of shelf life, it may be intended to add such optional flavoring substances before the heat treatment of the mixture and/or the individual components.

In one embodiment of the method according to the invention, which may be combined with any of the embodiments mentioned and yet to be mentioned, unless in contradiction therewith, the milk and the acidic component are mixed in a mixing ratio which, after homogenization and cooling, yields a mixture having a pH value which is in the ranee of 5.8 to 6.8.

In one embodiment of the method according to the invention, which may be combined with any embodiment mentioned and yet to be mentioned, unless in contradiction therewith, the milk and the acidic component are mixed in a mixing ratio which, after homogenization and cooling, gives a mixture having a pH value ranging from 6.2 to 6.8 and/or having an acidity ranging from 4.5° SH to 12.5° SH.

A mixture with a final pH in this range has been found to be particularly suitable for being produced as an end product stable with respect to flocculation simply by the choice of process parameters discussed here. A final product means here the finished product as it is bottled and ultimately sold in the store. If the final pH value is too low, the risk of undesirable flocculation during production and/or storage is again increased.

The ° SH specification refers to the acidity according to Soxhlet-Henkel.

In one embodiment of the method according to the invention, which may be combined with any of the embodiments mentioned and yet to be mentioned, unless in contradiction therewith, the milk and the acidic component are mixed in a mixing ratio which, after homogenization and cooling, gives a mixture having a pH value ranging from 6.3 to 6.6.

Depending on the components of the mixture used (in particular acidic component and milk), for example, the critical lower limit of the pH value of the mixture may change slightly. Factors such as the nature/type of acidic component used, its acidity and/or desired volume fraction in the final product, and/or the protein content of the milk used may have an impact on the pH and on the stability of the mixture. Fruits, for example, may contain more acid than coffee, so fruit-based mixtures may tend to be more acidic than coffee-based mixtures. In addition, the protein content of the milk may have a buffering and thus pH-stabilizing effect. For example, a mixture of skimmed milk, cream, sugar and fruit puree was measured to have a pH of approximately 6.2, and the mixture met the stability requirements. Accordingly, a lower pH value of the mixture may also be possible, although it has been shown that mixtures with a pH value below 5.8 do not exhibit the desired stability with respect to flocculation. For example, the formulation of Table 1 has a pH value between 6.5 and 6.6, measured on the final product.

On the other hand, the pH can be increased, for example, by adding a pH stabilizer, for example, in the case of a mixture of milk and coffee to 6.9 up to 7.0. A suitable upper limit of the pH of the mixture of milk and acidic component or of the end product is considered to be a pH of 7.0, particularly suitable is a pH of 6.9, especially a pH of 6.8 or even 6.6.

Thus, for a mixture of milk and the acidic component according to the invention, depending on the properties of the mixture, a final pH value may result which can be derived from the combination of one of the lower limits discussed above with one of the upper limits discussed above.

When referring to the pH of the mixture after homogenization and cooling, the inherent reference is to the pH on the final product (i.e. the final pH).

It may be particularly advantageous for the mixture, after homogenization and cooling, to have a pH that ranges from 6.3 to 6.6 and/or an acidity that ranges from 5.5° SH to 11.9° SH, for example, for a milk-coffee-based mixture.

In one embodiment of the method according to the invention, which may be combined with any of the embodiments mentioned and yet to be mentioned, unless in contradiction therewith, the mixture is—after cooling—first stored at a storage temperature and then filled after cooling, or the mixture is filled directly after cooling.

In one embodiment of the method according to the invention, which may be combined with any of the embodiments mentioned and yet to be mentioned, unless in contradiction therewith, the storage temperature is in a range of 4° C. to 25° C. The filling of the mixture may be carried out at the storage temperature. Typically, the filling is carried out into the appropriately provided container in which the finished mixture is to be sold. As mentioned above the storage temperature and/or the filling temperature can be adapted to the type of heat treatment applied (pasteurization, ultra-high temperature, sterilization).

In one embodiment of the method according to the invention, which may be combined with any of the embodiments mentioned and yet to be mentioned, unless in contradiction therewith, the acidic component is selected from a group comprising:

Fruit juice, fruit juice concentrate, fruit pulp, fruit puree and fruit preparations thereof, vegetable juice, vegetable juice concentrate, cereals and other fermented natural ingredients and preparations thereof, coffee, and/or tea, tea infusion and liquid tea extract, for example of powder or paste, and preparations thereof.

The acidic component has an acid pH value, i.e. a pH value below 7.0. Essential for the properties of the mixture of milk and the acidic component is actually less the pH value of the acidic component itself, but in connection with its share in the milk mixture and the resulting pH value of the mixture with the applied mixing ratio.

In one embodiment of the method according to the invention, which may be combined with any of the embodiments mentioned and yet to be mentioned, unless in contradiction therewith, the acidic component is coffee.

Coffee is understood here as a liquid component containing coffee. Coffee can, for example, be brewed bean coffee, or the product of a so-called cold brew process. The liquid coffee-containing component can also be dissolved powdered coffee, or coffee concentrate diluted back from paste or preparations thereof.

In one embodiment of the method according to the invention, which may be combined with any of the embodiments mentioned and yet to be mentioned, unless in contradiction therewith, the coffee is prepared from coffee beans. For this purpose, the coffee beans are first roasted. Depending on the equipment and/or coffee beans used, the roasting may be carried out at a temperature between 150° C. and 240° C., for example during a period of 10 to 20 min. A suitable roaster is, for example, a Probat roaster.

The roasted coffee beans are subsequently ground, and then subjected to a brewing process. The brewing process can be carried out, for example, in a higher temperature range, which is for example, in a range from 80° C. to 100° C., in particular in a range from 86° C. to 96° C. However, the brewing process may also be carried out in a lower temperature range if, for example, the coffee is to be produced according to the cold brewing process. In this case, the brewing process can be carried out in a temperature range from 2° C. to 25° C. In this process, the brewing typically takes place over a longer period of time, for example over several hours or days.

Suitable coffee beans are, for example Arabica varieties from Central America, South America, India or other places of origin, or blends thereof. Robusta varieties of various origins may also be suitable coffee beans.

The liquid coffee resulting from the brewing process can now be stored temporarily for up to 4 days, for example. A suitable storage temperature is in the range of 4° C. to 8° C. During an intermediate storage, the coffee can be heated from the storage temperature to a mixing temperature T_{MIX} and then added to the milk flow after the denaturation. Such pre-storage has the advantage that the coffee can be produced relatively independently of the milk and can be fed directly into the process from storage for the production of the cold coffee-milk mixed beverage.

It is equally possible for the freshly made coffee to be transferred directly from the brewing process to the milk flow for mixing. In this case, the coffee may need to be cooled or heated to set it to the mixing temperature or the coffee may be taken directly from the coffee stream at the desired mixing to temperature T_{MIX} and does not require an additional temperature treatment.

In one embodiment of the method according to the invention, which may be combined with any of the embodiments mentioned and yet to be mentioned, unless in contradiction therewith, the coffee is stored separately before mixing with the milk and preheated to a mixing temperature for mixing.

In one embodiment of the method according to the invention, which may be combined with any of the embodiments mentioned and yet to be mentioned, unless in contradiction therewith, the mixing temperature T_{MIX} is substantially equal to the denaturing temperature T_{DENAT} of the milk +/−15° C.

As previously mentioned, due to the separate denaturation treatment of the milk, the temperature at which the mixing takes place has no or no significant and thus negligible influence on the stability of the mixed milk beverage produced. The choice of temperatures for the and the coffee can therefore also be coordinated in view of process related considerations and energy related considerations.

For the production of a cold coffee-milk mixture, the fat content of the milk used can, for example, be in the range of 0.05% to 10%. The respectively used milk can be matched to the end product. For example, if cappuccino is to be made, milk with a fat content of about 1.5% is particularly suitable, while milk with a fat content of about 5.0% is particularly suitable for making a macchiato.

One aspect of the invention relates to the provision of a mixed beverage comprising milk and an acidic component, which is produced by the method according to the invention. The mixed beverage can be stably stored for at least 50 days without flocculation.

This stable storability refers to storage appropriate to the product. For example, pasteurized mixed beverages can be stored stably for at least 50 days at 4 to 10° C., while ultra-high temperature treated, mixed beverages can be stored for 50 days up to 3 or more months even at room temperature. It is currently believed that the previously performed denaturation of milk has significantly reduced the amount of milk proteins that can be flocculated after production. Stable storability in this context is thus understood to mean storage over the above-mentioned periods without visible flocculation. The presence of flocculation is assessed visually on the end product.

In one embodiment of the mixed milk beverage according to the invention, which may be combined with any of the embodiments mentioned or yet to be mentioned unless in contradiction therewith, the mixed milk beverage comprises:
Milk, and
the acidic component, and
flavoring substances, and/or
one or more additives selected from a group comprising:

stabilizers, emulsifiers and binders.

In this embodiment, it was thus possible to dispense with the use of an acidity regulator.

In one embodiment of the mixed milk beverage according to the invention, which may be combined with any of the embodiments mentioned and yet to be mentioned, unless in contradiction therewith, the mixed milk beverage consists of:
Milk, and
the acidic component, and
flavoring substances.

Thus, in this embodiment of the mixed milk beverage, no additives are used for stabilization.

In one embodiment of the mixed milk beverage according to the invention, which may be combined with any of the embodiments mentioned and yet to be mentioned, unless in contradiction therewith, the mixed milk beverage consists of milk and the acidic component. In this embodiment, any additives, including flavoring substances, have been omitted. This can be, for example, a product of milk and coffee (latte) or a milk-fruit juice mixture.

In one embodiment of the milk mix beverage according to the invention, which may be combined with any of the embodiments mentioned and yet to be mentioned, unless in contradiction therewith, the acidic component is coffee.

In one embodiment of the mixed milk beverage according to the invention, which may be combined with any of the embodiments mentioned and yet to be mentioned, unless in contradiction therewith, the acidic component is fruit puree.

In one embodiment of the mixed milk beverage according to the invention, which may be combined with any of the embodiments mentioned and yet to be mentioned, unless in contradiction therewith, the milk is:

Whole milk or skimmed milk or semi-skimmed milk or milk standardized in the fat content or cream or one or more milk fractions or a combination thereof. The milk or its composition can depend in particular on exactly which end product is to be produced. For example, for a cold cappuccino with coffee as the acidic component, a composition can be selected that has a fat content of approximately 1.5%, while for a macchiato, also with coffee as the acidic component, a composition can be selected that has a fat content of 5%. In addition to or as an alternative to the fat content of the milk, the viscosity or consistency in general can also be adjusted via the composition of the milk, for example.

In one embodiment of the mixed milk beverage according to the invention, which may be combined with any of the embodiments mentioned and yet to be mentioned, unless in contradiction therewith, the milk is: whole milk or skimmed milk or semi-skimmed milk or milk standardized in fat content or cream or a combination thereof. In addition, the milk comprises at least one milk fraction, which preferably comprises milk protein.

Especially by adding milk protein, the consistency of the later milk mixture can be influenced in a natural way.

It is currently assumed that the separate pretreatment of the milk without coffee extract or acidic component leads to a change in the protein structures in the milk, and thus stabilization is achieved during the further heat treatments to increase shelf life and subsequent homogenization, which are carried out by adding the acidic component, such as the coffee component, in a slightly acidic range. Thus, based on the process sequence alone, the addition of especially acidity regulators, stabilizers, emulsifiers, and/or binders can be omitted, if desired, without affecting the stability of the milk mixture with respect to possible flocculation.

Another aspect of the invention relates to a plant 1 for carrying out a method comprising the method steps and in the sequence as previously described. Depending on the embodiment of the method, the plant 1 may comprise additional elements. The plant 1 comprises at least the following devices and plant elements:
A denaturing device 2 for carrying out a separate denaturing treatment of the milk. With this denaturing device 2, the milk is heated to the denaturing temperature T_{DENAT} and kept at the denaturing temperature T_{DENAT} for the denaturing period t_{DENAT}. Such a denaturing device 2 may be, for example, a heat exchanger, such as a plate or tube heat exchanger.
A device 9 for combining the denatured milk and the acidic component to form a mixture. Since in this case streams are brought together, the mixing step takes place through the merging.
A device 3 for performing a heat treatment on the mixture to increase its shelf life. This device 3 is used to treat the mixture comprising milk from the denaturing treatment and the acidic component to increase its shelf life. Such a device 3 is adapted to heat the mixture to the necessary temperature T_{HALT} for the correlating time t_{HALT}, and accordingly to perform, for example, a pasteurization or an ultra-high temperature heating. The device may be, for example, a tubular or plate heat exchanger, or, if the heat treatment is carried out by infusion or uperization, a device according to the infusion or uperization method.
A first homogenizing device 4 for homogenizing the heat-treated mixture. The first homogenizing device 4 is designed to build up the desired homogenizing pressure P_{HOM}. Such a homogenizing device 4 may be, for example, a two-stage piston homogenizer. It may be possible that the homogenizing device 4 is functionally connected to a heat exchanger in order to heat the mixture to be homogenized to a desired homogenization temperature as described later.
A cooling device 5 for cooling the heat-treated and homogenized mixture to a storage temperature. The storage temperature can be in a range of 4° C. to 25° C., as already described above. The cooling device 5 can be, for example, a heat exchanger such as a plate heat exchanger or a tube heat exchanger.
Lines 6 for receiving milk and guiding a milk flow,
Lines 7 for receiving the acidic component and guiding a flow with the acidic component,
Lines 8 for receiving the mixture comprising the milk and the acidic component and for guiding the mixture flow,

and
A controller 10 for controlling the method according to any of the embodiments described above, or combinations thereof, as a continuous process.

In this context, a continuous process is understood to mean a method in which the respective individual components and the mixture are treated in a continuous sequence of method steps, i.e. essentially without interruption. The respective flows of liquid components (be it milk, the acidic component or the mixture) are continuously moved in a flowing manner from one device to the next. As a result, there is no so-called “batch production” here, in which the individual components or the mixture are processed batch by batch and brought together at the end as one overall product. The milk, the acidic component and the mixture are accordingly moved in the plant 1 according to the invention in continuously flowing streams from one device of the plant 1 to the next.

The individual components and the mixture are therefore moved in corresponding lines 6,7,8.

For a controlled transport of the fluids through the lines 6,7,8 and the various devices, the system 1 may comprise one or more operatively connected pressure pumps and/or valves with which a respective flow rate is controlled. Such pump(s) and/or valves may, for example, be operatively connected to one or more lines 6,7,8 for the control of the individual flow rates.

The controller 10 is configured to execute the method in an embodiment described above, or in a combination of embodiments, as a continuous process on the plant 1. For example, the controller may control the various devices and/or one or more lines 6,7,8 such that they are adapted to the volumes of fluid flows to be moved. This may be, for example, adjustments in the capacities of the devices and/or adjustments to regulate the respective volumes of fluid and their flow characteristics. For example, the controller 10 can be used to control a method in which the liquid flow of milk represents 75 to 95% of the total liquid volume, and the liquid flow of the acidic component represents 5 to 25% of the total liquid volume. Adjustments can be made individually for the desired end product.

The controller 10 is preferably further adapted to control the corresponding method parameters such as treatment times of the milk, the acidic component and/or the mixture such as t_{DENAT}, t_{HALT}, and/or treatment temperatures T_{DENAT}, T _{HALT}, T_{HOM}, T_{PRE}, T_{MIX}, and/or treatment pressures such as p_{HOM} and p_{PRE}, which are used, for example, during denaturation and/or during heat treatment to increase shelf life and/or for one or more homogenization steps, and/or to control them, if necessary, as a function of the line conditions, such as the length of the line and its diameter, and to the desired flow rate.

The device 9 for merging the milk flow and the flow with the acidic component is, for example, a simple T-connector. The merging can be controlled by means of one or more valves in the milk flow line 6 and/or the line 7 for the acidic component, in this case the coffee flow line by the controller. However, the device 9 for merging the milk flow and the flow with the acidic component can also have other line routing designs deviating from a T-piece, as long as it allows the two previously separately designed lines to be merged into a common mixture line. A metering valve can additionally control the merging.

The plant 1 may include additional cooling devices 5′, 5″, etc., to reduce the temperature of one or both of the individual components or the mixture in possible intermediate steps, if necessary. For example, it may be necessary to use a cooling device 5′ to cool the mixture of milk and the acidic component to a desired, lower homogenization temperature T_{HOM} after the heat treatment to increase shelf life. It is also possible, for example, to cool one of the individual components to a storage temperature for an intermediate storage step. For example, if coffee is used as an acidic component, a cooling device 5″ can be used to cool the coffee brewed from coffee beans to, for example, 4° C. for an intermediate storage step. Such cooling devices 5, 5′, 5″ can, for example, each be a heat exchanger such as a plate or tube heat exchanger.

The plant may additionally include one or more heating devices 12 to optionally preheat the corresponding fluids for a desired method step. Such a heating device may be a heat exchanger, for example.

In one embodiment of the plant according to the invention, which may be combined with any of the embodiments mentioned and yet to be mentioned, unless in contradiction therewith, the plant comprises a second homogenizing device 11. By means of this second homogenizing device, the prehomogenization of the milk is carried out as described above. The second homogenizing device 11 may be, for example, a two-stage piston homogenizer adapted to apply the desired prehomogenization pressure p_{PRE} to the milk. Preferably, the second homogenizing device 11 is functionally connected to a heating device 12 for heating the milk for prehomogenization to a desired prehomogenization temperature T_{PRE}.

In one embodiment of the plant according to the invention, which can be combined with any of the embodiments mentioned and yet to be mentioned, unless in contradiction therewith, the denaturing device 2 is a heat exchanger, preferably a plate heat exchanger or a tube heat exchanger. The denaturing device 2 comprises, if it is designed as a heat exchanger, a heat holding section which is designed in such a way that it can keep the milk hot for the required time. This can be realized, for example, by selecting the length, by selecting the diameter, or even by selecting the material of the corresponding line.

In one embodiment of the plant according to the invention, which may be combined with any of the embodiments mentioned and yet to be mentioned, unless in contradiction therewith, the device 9 for merging the denatured milk flow and the stream with the acidic component into a mixture is a tube-based connector, for example a T-connector, which preferably comprises a metering valve. Alternatively, the tube-based connector may have a shape other than a T-shape, for example a Y-shape, as long as the shape allows mixing or merging of the denatured milk flow with the stream with the acidic component as mentioned above.

In one embodiment of the plant according to the invention, which may be combined with any of the embodiments mentioned and yet to be mentioned, unless in contradiction therewith, the device 3 for carrying out the heat treatment is a heat exchanger, preferably a plate heat exchanger or a tubular heat exchanger, or an apparatus according to the infusion or uperization method. If the device 3 for carrying out the heat treatment is a heat exchanger, it comprises a heat-holding section which is designed in such a way that it can keep the milk hot for the required time. This can be carried out, for example, by selecting the length, by selecting the diameter, or even by selecting the material of the corresponding pipe.

In one embodiment of the plant according to the invention, which may be combined with any of the embodiments mentioned and yet to be mentioned, unless in contradiction therewith, the homogenizing, device 4 is a piston homogenizer.

In one embodiment of the plant according to the invention, which may be combined with any of the embodiments mentioned and yet to be mentioned, unless in contradiction therewith the cooling device 5 is a heat exchanger, preferably a plate heat exchanger or a tubular heat exchanger.

In one embodiment of the plant according to the invention, which may be combined with any of the embodiments mentioned and yet to be mentioned, unless in contradiction therewith the lines 6,7,8 connect the various devices in such a way that the devices are fluidically connected in a sequence such that the method is continuously carried out according to the inventive sequence described above:

By way of example, at least one line 6 for receiving the and guiding a milk flow is fluidically connected to the denaturing device 2 to guide the milk into the denaturing device 2. One or more further lines 6 for receiving and guiding the milk may also be provided, e.g. for feeding the milk into a heating device 12 before the milk is guided into the denaturing device 2. In this case, the milk may also be guided through a line 6 from the heating device 12 into the denaturing device. Similarly, by means of one or more lines 6, the milk flow can be guided from the denaturing device 2 to the device 9 for combining the denatured milk and the acidic component into a mixture; or else to and/or from one or more devices which are connected upstream of the denaturing device 2, for example a second homogenizing device 11 for prehomogenization and/or additional heating device 12, as described, for example, in connection with prehomogenization.

Also by way of example, at least one line 7 for receiving the acidic component and conducting a flow with the acidic component is fluidically connected to the device 9 for merging the denatured milk and the acidic component into a mixture in order to guide the acidic component into this device 9. It may be provided that one or more lines 7 ensure the flow of the acidic component to and/or from devices upstream of the mixing device, for example if the acidic component is to be heated in an additional heating device 12 before mixing with the milk.

Also by way of example, at least one line 8 for receiving the mixture and guiding the mixture flow fluidically connects the device 9 for combining the milk and the acidic component with the device 3 for heat treatment of the mixture. Additional lines 8 may be provided to guide the mixture flow, for example, from the device 3 for the heat treatment, for example, to and/or from a cooling device 5, 5′ and/or the first homogenizing device 4 and/or the intermediate storage.

By way of example, reference is made to the plant 1 as described in FIG. 3.

For range specifications, the mentioned basic parameters are included in the range.

### BRIEF DESCRIPTION OF THE FIGURES

Exemplary embodiments of the present invention are explained in more detail with reference to figures, wherein:

FIG. 1 shows the main steps of the method in a schematic block diagram;

FIG. 2 shows in a further, schematized block diagram a special embodiment of the method for the production of a cold coffee-milk mixture with additional, optional steps, and

FIG. 3 shows a schematic block diagram of a plant in which the various plant elements for carrying out a continuous method are arranged.

### DETAILED DESCRIPTION OF THE FIGURES

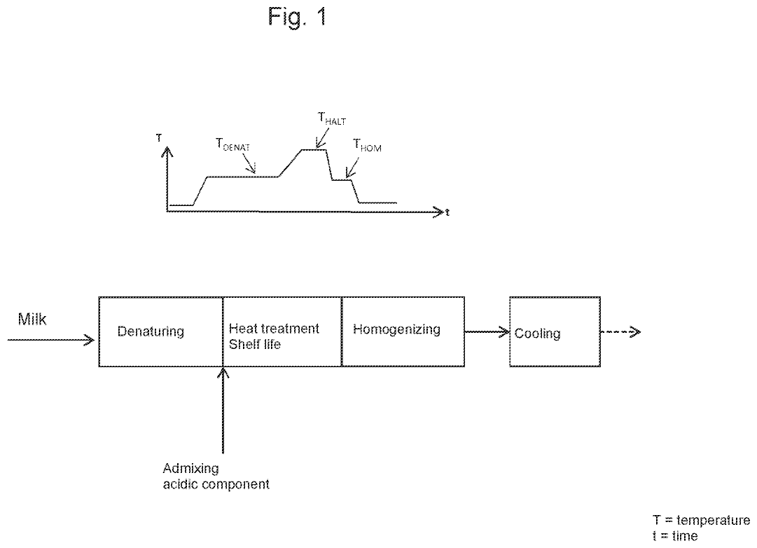

FIG. 1 shows a schematic block diagram of the main steps of the method. Milk alone, i.e. without the addition of the acidic component, is subjected to a denaturing step. Immediately afterwards, the acidic component is added. Due to the temperature treatment, this mixing step is less susceptible to flocculation. The resulting mixture is then subjected to a heat treatment, which is necessary to increase shelf life. The heat-treated mixture can then be homogenized and finally cooled. The resulting mixture is stable to flocculation.

Above the block diagram a highly schematized temperature curve is shown. In this case, the heat treatment of the mixture to increase shelf life takes place at a higher temperature T_{HALT} than denaturation of the milk T_{DENAT}, while homogenization takes place at a slightly lower temperature T_{HOM} than the denaturation. Subsequently, the temperature drops sharply, which in this case corresponds to cooling to a lower temperature for storage, for example.

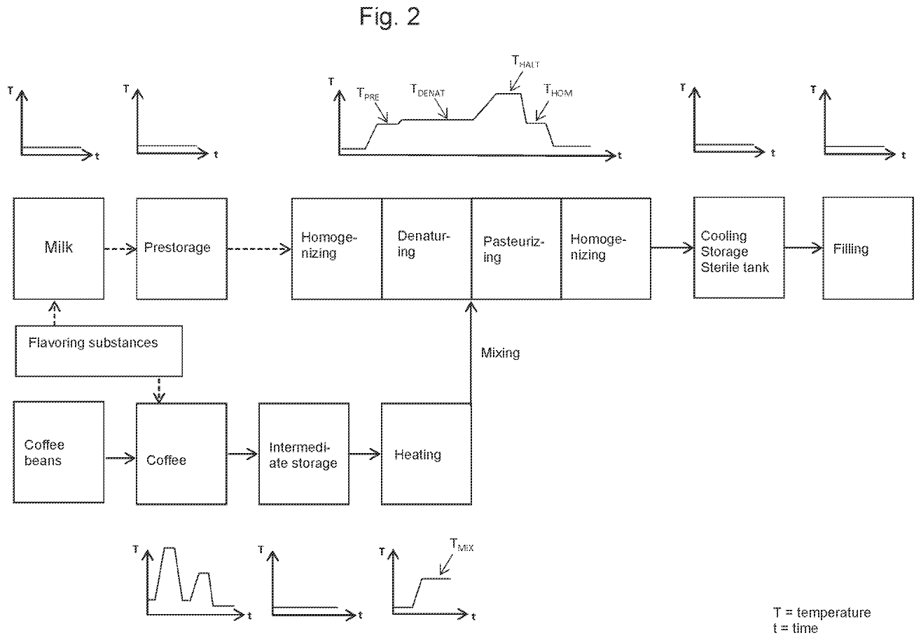

FIG. 2 shows a in schematic block diagram an exemplary embodiment of the method for producing a cold coffee-milk mixture with additional, optional steps. For the sake of clarity, an exemplary temperature curve for the respective steps is also shown here.

This method is based on the of formulation according to Table 1:

TABLE 1

| | SHARE IN |
|---|---|
| INGREDIENT | FORMULATION |
| Whole milk | 75 g/100 g |
| Brewed coffee | 17 g/100 g |
| Cream | 5 g/100 g |
| Sugar | 3 g/100 g |

The desired milk is provided and stored until the desired start of the manufacturing process. For this purpose, the milk can have a temperature in a range of 4° C. to 8° C., for example. In this case, the milk is stored in a 4° C. storage room.

Coffee is provided by obtaining a brewed coffee from coffee beans. For this purpose the beans are first roasted at a relatively high temperature, for example in a range of 150° C. to 240° C. The roasted coffee beans are then ground, and then brewed at a slightly lower temperature. For example, the brewing temperature may be in the range of 85° C. to 97° C. In this example, the coffee is brewed at 88° C. to 92° C. The coffee produced in this way is then first stored cooled in an intermediate storage at a temperature in the range of 4° C. to 10° C., in this case in a 4° C. storage room, until it can be fed to the milk flow. The temperature curve of the coffee drops accordingly.

Flavoring substances can be added to either the milk or the coffee, or both. This is indicated by the dashed arrows. In this exemplary method, sugar is added to the milk component and subjected to the denaturing step together with it.

In this illustrated method, the upstream milk is subjected to a first “prehomogenization” and preheated to the corresponding temperature T_{PRE} for this purpose. In this case, the temperature of the prehomogenization T_{PRE} can be in the range of 65° C. and 75° C., for exam pie at a pressure between 150 and 200 bar. The milk is then heated further, to the denaturing temperature T_{DENAT}, and denaturation of the milk takes place, for example, for 120 sec or up to 300 sec at approximately 90° C.

At the same time, the temporarily stored coffee is also heated to a mixing temperature and then added to the milk after denaturation. In this case, the mixing temperature T_{MIX} is also around 90° C.

The resulting mixture of milk and coffee is then heated further to a pasteurization temperature T_{HALT}, which in this case can be in the range of 120° C. to 133° C. Specifically, a temperature of 72° C. was applied here for 15 sec for pasteurization. During this heat treatment, vegetative germs are killed and the milk mixture is thus rendered low of germs.

Immediately after pasteurization, the mixture is then homogenized again. In this case, homogenization takes place at a temperature T_{HOM} in a range of 65° C. to 70° C., so that the mixture is cooled for homogenization. Cooling can be carried out, for example, with a tubular or plate heat exchanger.

Homogenization of the mixture takes place, for example, at a pressure in a range of 100 to 150 bar. Subsequently, the homogenized mixture is cooled to a storage temperature which is in a range of 5° C. to 10° C. and stored in a sterile tank. Once this is desired, the cooled mixture can then be filled at the storage temperature. Filling is usually carried out into such containers in which the final mixture product is to be sold later.

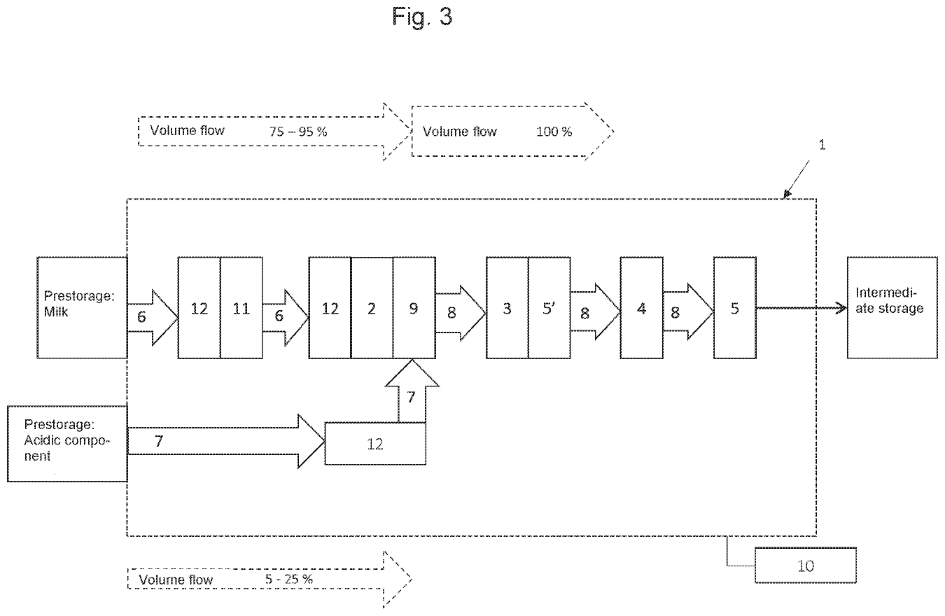

FIG. 3 shows in a schematized block diagram a plant 1 in which the various plant elements for carrying out a continuous method are arranged. This plant 1 is particularly suitable for a method as described for FIG. 2, in which coffee is used as the acidic component, wherein the steps described below are controlled with the settings described above by means of the controller 10.

In a first liquid flow, the milk is first taken from a preliminary storage, for example a storage tank at 4° C., and fed to the second homogenizing device 11 via one or more lines 6 for the milk flow. Flavoring substances can be added to the milk, for example, directly after removal from the preliminary storage, as described in connection with FIG. 2. The second homogenizing device 11 is designed to carry out the previously described prehomogenization of the milk. In the plant described here by way of example, after storage the milk is first passed over a heating device 12, in this case a heat exchanger, with which the milk is preheated to the prehomogenization temperature T_{PRE}. Immediately thereafter, the milk is then fed into the second homogenizing device 11 for prehomogenization.

Subsequently, the now prehomogenized milk is first further heated to the desired denaturing temperature T_{DENAT} via lines 6 by means of a heating device 12 and immediately thereafter passed to the denaturing device 2, where it is subjected to the denaturation treatment as described above. For the formulation referred to in FIG. 2, the volume of the milk flow is 75% by volume (Vol %) of the total volume. The total volume here is the volume of the final mixed product of milk and the acidic component, as in this case coffee. The lines 6 are suitably designed for the controlled transport of the milk flow with such a volume. By means of the controller 10, it is ensured, for example, that the desired denaturing period t_{DENAT} is not significantly exceeded or undercut for the given line characteristics and flow rates. This also applies to the other treatment times.

At the same time, liquid, brewed coffee is taken from the pre-storage and preheated to the desired mixing temperature T_{MIX} by means of a heating device 12. For the formulation mentioned for FIG. 2, the volume of the coffee stream is 25 percent by volume (Vol %) of the total volume. For this purpose, the coffee is first transported to the heating device 12 and then onward via appropriately designed coffee flow hues 7.

Immediately after the denaturation treatment of the milk, the coffee stream from coffee flow line 7 is combined with the preheated coffee and the milk flow from milk flow line 6 by means of a device 9 for merging the milk flow and the acidic component stream. The subsequent devices and lines 8 are adapted to the corresponding final volume (100 percent by volume) under the control of a controller.

The final mixture at hand is then fed via lines to a device 3 for carrying out heat treatment of a mixture to increase its shelf life, where it is subjected to the appropriate heat treatment. In this case, it is a pasteurization device, more precisely a tubular heat exchanger. In this case, the temperature T_{DENAT} of the treatment to increase shelf life is higher than the denaturing temperature T_{DENAT} of the milk and the mixing temperature T_{MIX} of the coffee. Therefore, the mixture for the heat treatment to increase shelf life is preheated to the temperature T_{HALT} via the tubular heat exchanger and held for pasteurization for the appropriate time.

The pasteurized mixture of milk and coffee is now fed to the first homogenizing device 4 via lines 8. In this case, this is a two-stage piston homogenizer, with which the pressure P_{HOM} described in FIG. 2 and at the temperature T_{HOM} are applied to the mixture.

Since this homogenization takes glace at a lower temperature than pasteurization, before the mixture enters the first homogenizing device 4, it is cooled from the pasteurization temperature T_{HALT} to the homogenization temperature by means of a cooling device 5′, in this case a heat exchanger, and then passed on to the homogenizing device 4.

Finally, the pasteurized and homogenized milk-coffee mixture is fed from the homogenizing device 4 to the cooling device 5, in this case a heat exchanger, by means of appropriate mixture flow lines 8, where it is cooled to the desired storage temperature. Since in this method the mixture has been pasteurized, a storage temperature of 4° C. is selected. Storage can now take place in one or more sterile tanks, for example, it can also be provided that filling into the corresponding containers takes place immediately after cooling.

Each of the steps described herein and the devices used are under substantially complete control of the controller 10.

### LIST OF REFERENCE NUMERALS

1 Plant

2 Denaturing device

3 Device for performing a heat treatment of a mixture to increase its shelf life,

4 First homogenizing device

5,5′ Cooling device

6 Milk flow lines

7 Lines for acidic component flow

8 Mixture flow lines

9 Device for merging the milk flow and the acidic component flow

10 Controller

11 Second homogenizing device

12 Heating device

1. Method for producing a cold mixed beverage made of milk and an acidic component, wherein the method comprises the following steps in this order:
a denaturing step of the milk, wherein the milk is heated to a denaturing temperature T_{DENAT} which is in a range of 72° C. to 155° C. prior to mixing with the acidic component, and is maintained at the denaturing temperature T_{DENAT} for a denaturing period t_{DENAT},
then mixing the denatured milk with the acidic component to form a mixture,
heat treating the mixture to increase shelf life, wherein the mixture is heated to a temperature T_{HALT} which is in a range of 63° C. to 155° C., and maintaining the mixture at the temperature T_{HALT} for a heat treatment period t_{HALT},
homogenizing the heat-treated mixture at a homogenizing pressure Pₕₒₘ which is in a range of 75 bar to 275 bar, and
cooling the mixture to a temperature that is in the range of 4° C. to 25° C.,
wherein the milk and the acidic component are mixed in such a mixing ratio that the mixture, after homogenization and cooling, has a pH value which is in a range of 5.8 and 7.0.

2. Method according to claim 1, characterized in that a degree of denaturation of a native whey protein β-lactoglobulin B is produced by means of the denaturing step of the milk which is in a range from 60% to 100%.

3. Method according to claim 1, characterized in that the denaturing period t_{DENAT} is in a range from 30 sec to 1 h.

4. Method according to claim 3, characterized in that the denaturing period t_{DENAT} is in a range from 60 sec to 420 sec, preferably in a range from 100 sec to 320 sec.

5. Method according to claim 3, characterized in that the denaturing step of the milk is carried out at a denaturing temperature T_{DENAT} in a range of 86° C. to 95° C.

6. Method according to claim 1, characterized in that the homogenization of the heat-treated mixture is carried out at a temperature Tₕₒₘ which is in a range from 65° C. to 80° C.

7. Method according to claim 1, characterized in that the heat treatment of the mixture is a pasteurization, wherein the temperature T_{HALT} is in a range of 63° C. to 133° C. and the heat treatment period t_{HALT} is in a range of 2 sec to 2000 sec.

8. Method according to claim 1, characterized in that the heat treatment of the mixture is a ultra-high temperature heating, wherein the temperature T_{HALT} is in a range of 130° C. to 155° C. and the heat treatment period t_{HALT} is in a range of 1 sec to 30 sec.

9. Method according to claim 1, characterized in that the milk is prehomogenized immediately prior to the denaturing step, wherein the prehomogenization pressure pₚᵣₑ is in a range from 100 bar to 300 bar, preferably in a range from 150 to 250 bar.

10. Method according to claim 9, characterized in that the prehomogenization is carried out at a temperature Tₚᵣₑ which is in a range from 65° C. to 80° C.

11. Method according to claim 1, wherein the milk and/or the acidic component comprises flavoring agents.

12. Method according to claim 1, characterized in that the milk and the acidic component are mixed in such a mixing ratio that the mixture, after homogenization and cooling, has a pH value that is in a range from 6.2 to 6.8, preferably in a range of 6.3 to 6.6, and/or in that the mixture, after homogenization and cooling, has a degree of acidity which is in a range of 4.5° SH to 12.5° SH, preferably in a range of 5.5° SH to 11.9° SH.

13. Method according to claim 1, characterized in that the mixture is first stored after cooling at a storage temperature and then filled, or in that the mixture is filled directly after cooling.

14. Method according to claim 13, characterized in that the storage temperature is in a range of 4° C. to 25° C., and/or in that the filling is performed at the storage temperature.

15. Method according to claim 1, characterized in that the acidic component is selected from a group comprising:
fruit juice, fruit juice concentrate, fruit pulp, fruit puree and fruit preparations thereof, vegetable juice, vegetable juice concentrate, cereals and other fermented natural ingredients and preparations thereof, coffee and liquid coffee extract, and preparations thereof, and/or tea, tea infusion and liquid tea extract, and preparations thereof.

16. Method according to claim 1, characterized in that the acidic component is coffee or a liquid coffee extract.

17. Method according to claim 16, characterized in that the coffee is stored separately before mixing with the milk and is preheated to a mixing temperature T_{MIX} for mixing.

18. Method according to claim 17, characterized in that the mixing temperature T_{MIX} essentially corresponds to the denaturing temperature T_{DENAT} of the milk +/−15° C.

19. Mixed beverage of milk and an acidic component, prepared according to claim 1, characterized in that the mixed beverage can be stored stably for at least 50 days without flocculation.

20. Mixed milk beverage according to claim 19, which consists of
milk, and
the acidic component, and
flavoring substances, and
one or more additives selected from a group comprising: stabilizers, emulsifiers and binders.

21. Mixed milk beverage according to claim 19, which consists of
milk, and
the acidic component, and
flavoring substances.

22. Mixed milk beverage according to claim 19, characterized in that it consists of milk and the acidic component.

23. Mixed milk beverage according to claim 19, characterized in that the acidic component is coffee.

24. Mixed milk beverage according to claim 19, characterized in that the acidic component is fruit puree.

25. Mixed milk beverage according to claim 19, characterized in that the milk is:
whole milk or skimmed milk or semi-skimmed milk or milk standardized for fat content or cream or one or more milk fractions or a combination thereof.

26. Mixed milk beverage according to claim 19, characterized in that the milk is:
whole milk or skimmed milk or semi-skimmed milk or milk standardized for fat content or cream or a combination thereof,
and in that the milk comprises at least one milk fraction which preferably comprises milk protein.

27. Plant (1) for carrying out a method having the method steps and in the sequence according to claim 1 for producing a cold mixed milk beverage made of milk and an acidic component, wherein the plant (1) comprises at least the following devices and plant parts:
a denaturing device (2) for carrying out a separate denaturing treatment of the milk,
a device (9) for mixing the denatured milk and the acidic component to form a mixture,
a device (3) for performing a heat treatment on the mixture to increase its shelf life,
a homogenizing device (4) for homogenizing the heat-treated mixture,
a cooling device (5) for cooling the heat-treated and homogenized mixture to a storage temperature,
characterized in that the plant is adapted to perform the method continuously, wherein the milk, the acidic component and the mixture are moved in continuously flowing streams from one device of the plant (1) to the next, and wherein the plant (1) further comprises:
lines (6) for receiving the milk and guiding a milk flow,
lines (7) for receiving the acidic component and guiding a flow with the acidic component,
lines (8) for receiving a mixture comprising the milk and the acidic component and for guiding a mixture flow,
and
a controller (10) for controlling the method according to one of claims 1 to 16 as a continuous method.

28. Plant (1) according to claim 27, characterized in that the denaturing device (2) is a heat exchanger, preferably a plate heat exchanger or a tube heat exchanger.

29. Plant (1) according to claim 27, characterized in that the device (9) for merging the denatured milk flow and the flow with the acidic component into a mixture is a tube-based connector, for example a T-connector, preferably comprising a metering valve.

30. Plant (1) according to claim 27, characterized in that the device (3) for carrying out the heat treatment is a heat exchanger, preferably a plate heat exchanger or a tube heat exchanger, or an apparatus according to the infusion or uperization method.

31. Plant (1) according to claim 27, characterized in that the homogenizing device (4) is a piston homogenizer.

32. Plant (1) according to claim 27, characterized in that the cooling device (5) is a heat exchanger, preferably a plate heat exchanger or a tube heat exchanger.
